(19) United States
(12) Patent Application Publication
(10) Pub. No.: US 2021/0339822 A1
(43) Pub. Date: Nov. 4, 2021

(54) DEVICE FOR THE SELECTIVE POSITIONING OF THE PIVOT OF A WHEEL

(71) Applicant: FANTIC MOTOR S.P.A., Casier (IT)

(72) Inventors: Mariano ROMAN, Noale (IT); Enrico FIDELFATTI, Camisano Vicentino (IT)

(73) Assignee: FANTIC MOTOR S.P.A., CASIER (IT)

(21) Appl. No.: 17/231,577

(22) Filed: Apr. 15, 2021

(30) Foreign Application Priority Data
Apr. 30, 2020 (IT) 102020000009499

(51) Int. Cl. B62K 25/28; B62M 9/125

(52) U.S. Cl. CPC B62K 25/28; B62K 2025/047; B62M 9/125

(57) ABSTRACT

A device for the selective positioning of the pivot of a wheel of a bicycle comprising a frame composed of a rear stay provided with a first pair of first oblique rear chainstays, each connected, respectively by means of a triangular support, to a second pair of two second horizontal rear chainstays, a derailleur hook being associable with the first and second chainstays.

First external seats and second internal seats are provided for the axial and removable positioning respectively of a first external adapter and of a second internal adapter.

The first and second adapter have respectively a second hole and a third hole, adapted to determine two different axial arrangements of the derailleur hook and of the pivot with respect to the two first and second chainstays and are adapted to keep the derailleur hook locked in clockwise rotation and free to rotate counterclockwise only through a chosen arc.

The present invention relates to a device for the selective positioning of the pivot of a wheel, particularly for bicycles, particularly but not exclusively of the pedal-assist type, for example for city use.

Bikes or bicycles of the known type are usually constituted by a frame composed of various tubular elements so as to obtain a structure composed of a top tube connected at one end to a head tube and at the other end to a rear vertical tube and to a saddle post.

Two oblique rear chainstays or dropouts are usually connected at the connection of the saddle post and/or of the top tube and/or of the vertical tube, while horizontal rear chainstays or dropouts are connected at the connection of the downtube and of the vertical tube, are connected at their ends to the two oblique rear chainstays or dropouts and have a seat for an axle of a wheel.

Moreover, a brake caliper can be connected to the chainstays or dropouts.

In the bicycle sector, wheel fixing systems are known which are of the type comprising a quick coupling which is fixed to the ends of the hub of the wheel, said hub ends being insertable at adapted seats provided at the ends of the chainstays or dropouts.

Usually, the dimensions and shape of the chainstays or dropouts are designed to receive a wheel axle or wheels of given dimensions, various choices for example of wheels from 27.5″ to 29″, being commercially available, these dimensions being correlated to the diameter of the rim, which in the case of 29″ wheels is 622 mm or 28 inches.

A bicycle of the known type, for example designed for 27.5″ wheels, is not compatible with 29″ wheels.

Vice versa, if a bicycle is designed for 29″ wheels it can mount 27.5″ wheels, but if the wheel axis is not modified the dynamics is not optimized.

As a partial solution to this drawback, FR3046400B1 is known which discloses a solution related to a rear stay of a bicycle which comprises a frame and a rear dropout which supports the axle of the hub of a wheel and one end of which comprises, on the external surface, a seat for first adapter that is shaped complementarily, the adapter having an eccentric threaded hole adapted to receive the thread of the axle of the hub of the rear wheel so that the position of the threaded hole can be modified by positioning the first adapter in one direction or in the other direction in the seat in order to adapt the position of the hole as a function of the height of the side wall of the wheel.

Two screws are provided which are adapted to be positioned on adapted holes provided in the seat of the first adapter in order to allow the fixing of the latter to the dropout.

There is a second adapter provided with an eccentric through hole, also capable of receiving the axle of the hub of the wheel, provided on the other dropout of the rear stay.

The eccentricity of the threaded hole of the first adapter corresponds to the eccentricity of the through hole provided in the second adapter.

Two adapted screws are also present in order to allow the fixing of the second adapter to the corresponding dropout.

There is also a derailleur hook which is also locked to the dropout by means of the screws for fixing the adapter to the dropout.

This solution allows, when wheels of different diameter are changed, to remove the first wheel, then invert the adapters, mount the second wheel having different dimensions and lock the two adapters to the dropouts.

However, even this solution has drawbacks; the presence of the threaded hole on the first adapter in fact increases the time required to perform wheel changing, as well as the need to fix, by means of screws, the first and second adapters to the respective dropouts, which must be disassembled beforehand in order to be able to remove the wheel that one wishes to replace with one having a different diameter.

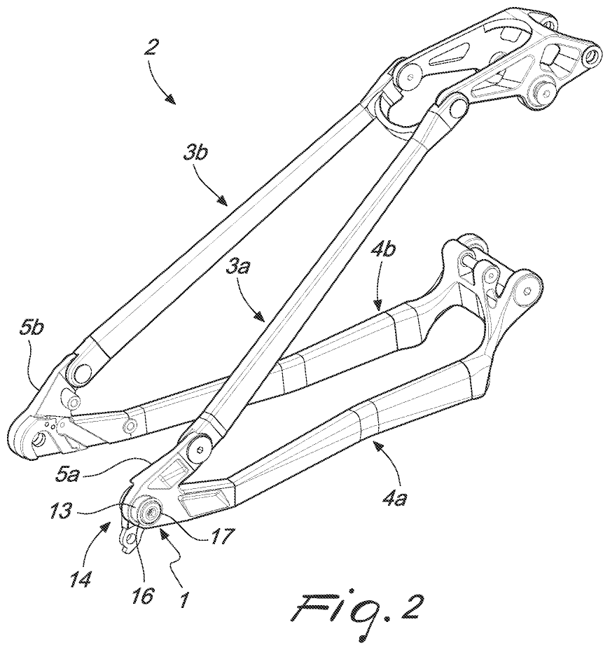

Furthermore, the displacement of the two wheel axes is parallel to the ground; therefore, the surface that locks the wheel is parallel to the ground (see FIG. 2) and if, however, the wheel axes were not parallel to the ground said surface would have to be inclined and in this situation it would not be a true “stroke limiter” during the insertion of the hub, since the hub would slide along the inclined surface without stopping in the correct position.

US 2019/0322333 is also known which discloses a derailleur hook in which there is a brake element configured for installation on an axial internal side of a portion of an associated bracket of a bicycle frame in order to install a rear gearshift mechanism of a derailleur system on the bicycle frame.

The brake element can include a first portion, which has an opening or an opening assigned to the axis and which, in the installed state, is subject to a fastening force that acts between the rear bracket portion.

The brake element can also include a second portion which has an installation opening that is radially offset with respect to the opening or opening in the installed state with respect to the axis and to which it is possible to fix one end of a coupling of a base element of the mechanism of the rear gearshift.

In this solution, the connection of the derailleur hook to the chainstays occurs by means of a rotatable coupling between the derailleur hook itself and the through pivot of the wheel.

The aim of the present invention is therefore to overcome the described technical problems, eliminating the drawbacks of the cited background art and thus devising a device for the positioning of a pivot of a wheel that allows to achieve rapidly and simply the installation on the rear stay of a bicycle of wheels of a different diameter despite the presence of a derailleur hook.

Within this aim, an object of the invention is to allow the cyclist to be able to modify rapidly and simply in particular the position of the axis of the wheel in passing from 27.5″ to 29″.

Another object of the invention is to devise a device for the selective positioning of the axis of a wheel allows quick and easy wheel changing in a bicycle and at the same time is provided in a small number of parts, is mechanically and constructively simple and strong, has low manufacturing and assembly costs, and does not require to be provided with specific fixing holes on the chainstays or dropouts.

Another object of the invention is to devise a device that has high reliability and safety and at the same time has a small overall weight.

Another object is to provide a device that can be disassembled and reassembled rapidly and easily even by personnel that is not particularly trained.

Another object is to provide a device that combines with the preceding characteristics that of being used in a frame of a bicycle with a derailleur hook applied thereto that is simple, has low costs for its provision and the application of which allows, in case of impact of the derailleur against an object during racing, to rotate through a certain free arc and thus avoid breakage.

The mentioned aim and objects, as well as others which will become better apparent hereinafter, are achieved by a device for the selective positioning of the pivot of a wheel of a bicycle comprising a frame composed of a rear stay provided with a first pair of first oblique rear chainstays which are each connected, respectively by means of a triangular support, to a second pair of two second horizontal rear chainstays, a derailleur hook being associable with said first chainstays and second chainstays, characterized in that first external seats and second internal seats are provided at the first internal surface and at the first external surface of said support for the axial and removable positioning respectively of a first external adapter and of a second internal adapter and have respectively a second hole and a third hole, both of which are smooth and are adapted to determine two different axial arrangements of said derailleur hook and consequently of said pivot of said wheel with respect to said two first and second chainstays and are adapted to keep said derailleur hook locked in clockwise rotation and free to rotate counterclockwise only through a chosen arc.

Further characteristics and advantages of the invention will become better apparent from the detailed description of a particular but not exclusive embodiment, illustrated by way of non-limiting example in the accompanying drawings, wherein:

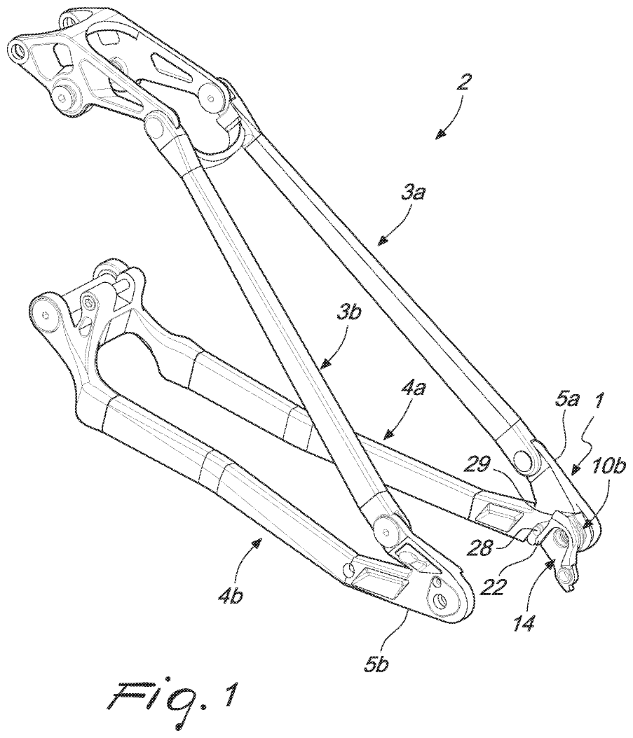

FIG. 1 is a first lateral perspective view of an example of a frame for bicycles with the device according to the invention applied in the condition for use of a smaller-diameter wheel;

FIG. 2 is a second lateral perspective view, similar to the preceding one;

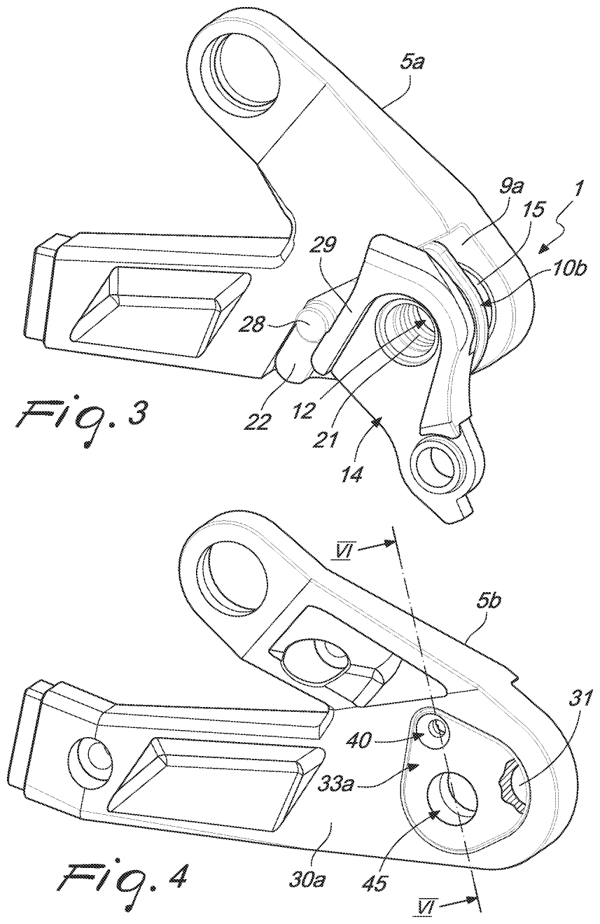

FIG. 3 is a first internal lateral perspective view of the terminal part of the frame with which the device of the invention is associated in the condition for use of a smaller-diameter wheel;

FIG. 4 is a first lateral perspective view of the terminal part of the frame which the device of the invention is associated in the condition for use of a smaller-diameter wheel;

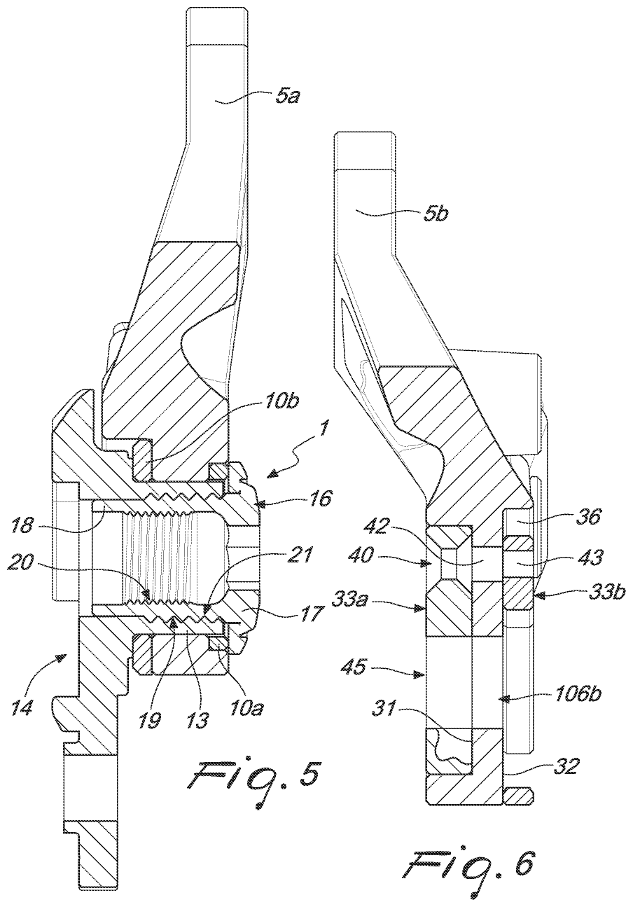

FIG. 5 is a sectional view of the device of the invention in the condition for use of a smaller-diameter wheel;

FIG. 6 is a sectional view, taken along the plane VI-VI of FIG. 4;

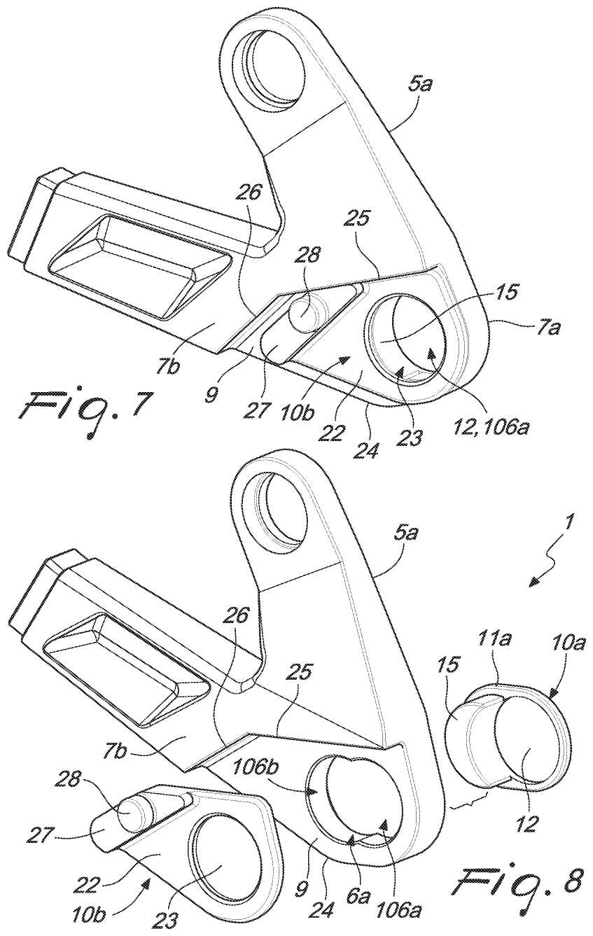

FIG. 7 is a lateral perspective view of the device applied in the condition for use of a larger-diameter wheel;

FIG. 8 is an exploded view of the device according to the preceding figure;

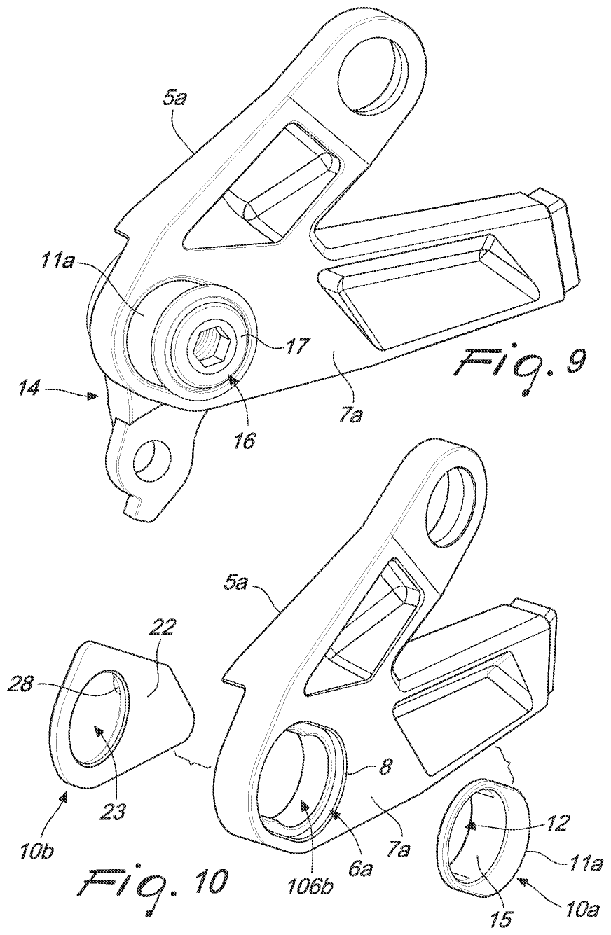

FIG. 9 is a second internal lateral perspective view of the device in the condition for use of a smaller-diameter wheel;

FIG. 10 is an exploded view of the device;

FIG. 11 is an exploded view of various components;

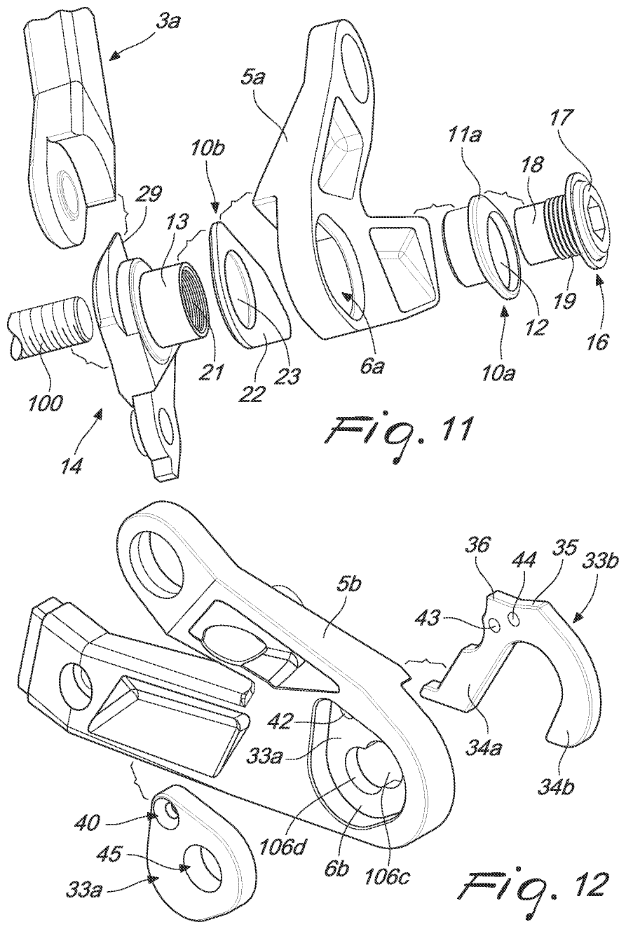

FIG. 12 is an exploded view of the components according to FIG. 4;

FIGS. 13 and 14 are a perspective view and an exploded view of the third external adapters and of the fourth internal adapters in the condition for use of a larger-diameter wheel;

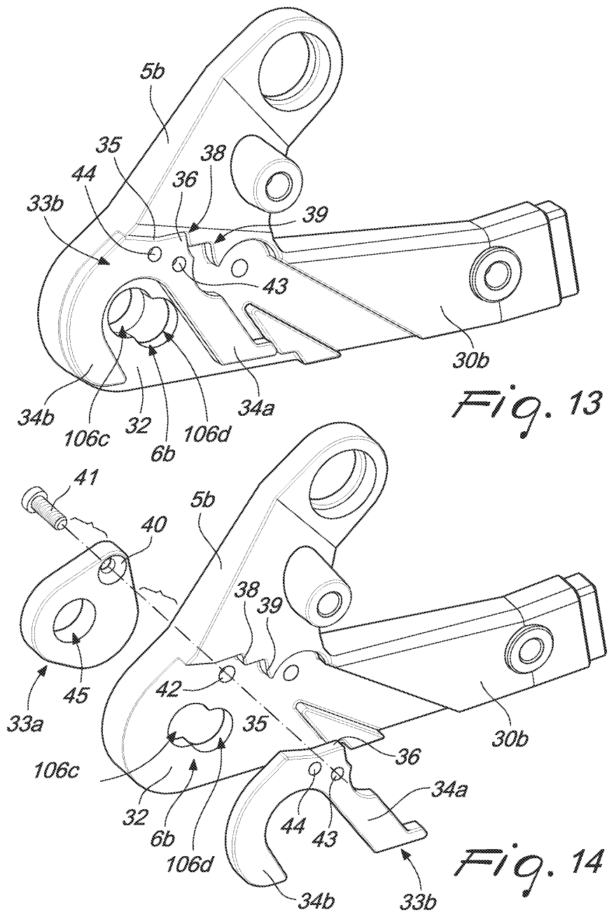

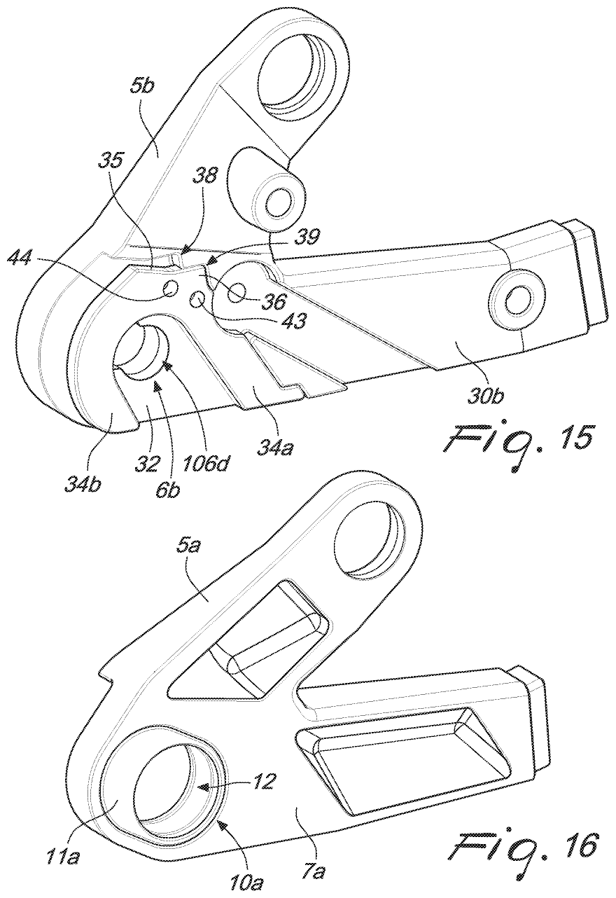

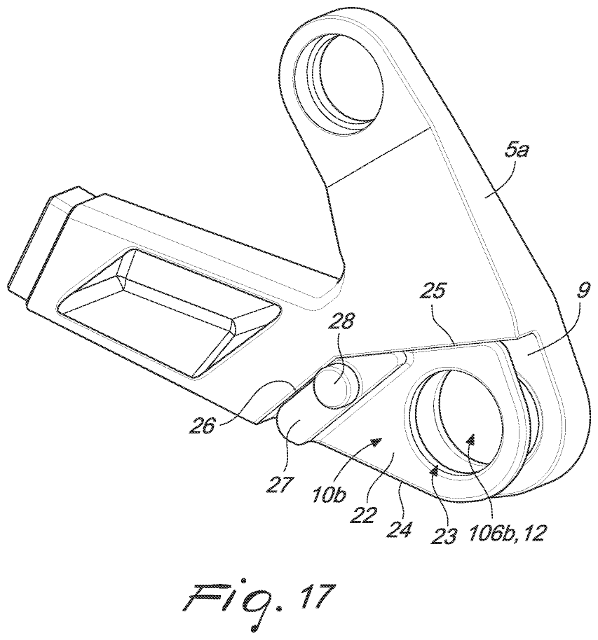

FIGS. 15, 16 and 17 are views of the third external adapters and of the fourth internal adapters in the condition for use of a smaller-diameter wheel.

In the embodiments that follow, individual characteristics, given in relation to specific examples, may actually be interchanged with other different characteristics that exist in other embodiments.

With reference to the figures, the reference numeral 1 designates a device for the selective positioning of the pivot 100 of a wheel (not shown) of a bicycle (not shown), of the electric type or not, comprising a frame which is constituted by a rear stay 2 which comprises two first oblique rear chainstays or dropouts 3a, 3b (3a being also referenced as right and 3b as left) and two second horizontal rear chainstays or dropouts 4a, 4b (4a being also referenced as right and 4b as left), which are mutually connected at the ends by a triangular support 5a, 5b.

Such first and second chainstays or dropouts 3a, 3b, 4a, 4b have, at the corner of the triangular supports 5a (also referenced as right), 5b (also referenced as left), a first hole 6a, 6b which has a figure-of-eight shape; the first hole 6a forms two circles 106a, 106b, which are contiguous, mutually identical and partially mutually intersect, both have smooth internal surfaces, and in turn determine two different conditions for the arrangement of a derailleur hook 14 (described hereinafter) and consequently of the pivot 100 of the wheel.

A first external seat 8 and a second internal seat 9 are provided at the first external surface 7a and at the first internal surface 7b of said support 5a, which is connected to the first right chainstay 3a and to the second right chainstay 4a, for the axial and removable positioning respectively of a first external adapter 10a and of a second internal adapter 10b.

The first external adapter 10a has a first head 11a having a substantially elliptical plan shape which is provided with a second hole 12, which is not threaded and eccentric, with a diameter that is substantially equal to the diameter of the sleeve 13 of the derailleur hook 14 of the known type, which can be traced back for example to US 2019/0322333 or to the UDH model of the company SRAM DEUTSCHLAND GmbH, such second hole 12 having a diameter that is substantially equal to the diameter of one of the circles 106a and 106b.

A first stem 15 protrudes on the side of the first head 11a that is opposite the side on which the second hole 12 is provided, is therefore axially offset with respect to the second hole 12 and is shaped so that it can be inserted selectively in one of the two circles 106a and 106b following a 180° rotation of said first external adapter 10a.

One therefore reaches two possible configurations, shown for example in FIGS. 3 and 7, in which it is possible to determine two different axial arrangements of the derailleur hook 14 and consequently of said pivot 100 of said wheel with respect to said support 5a of said first chainstay 3a.

When the first stem 15 is inserted in the circle 106a one has the smaller-diameter wheel condition (see for example FIG. 9).

When the first stem 15 is inserted in the circle 106b one has the larger-diameter wheel condition (see for example FIG. 7).

A cap or cover 16 also contributes to constitute the derailleur hook 14 and comprises a second head 17, which has a diameter equal to or greater than that of the second hole 12, from which a second stem 18 protrudes axially which has an external thread 19 that is threaded complementarily to the second internal thread 21 of the sleeve 13 and a first internal thread 20 which is threaded complementarily to the terminal end of the pivot 100 of the wheel.

The second internal seat 9 has a substantially scalene trapezoid shape with a longer parallel side 24 which follows the shape of the lower side of the support 5a, a shorter parallel side 25 which has, from the corner of the support 5a toward the second chainstay 4a, a given inclination toward the underlying longer parallel side 24 and an oblique side 26 for connection between the longer parallel side 24 and the shorter parallel side 25 that is directed toward the second chainstay 4a.

The second internal adapter 10b is constituted by a plate 22 which is shaped complementarily to the second internal seat 9, is substantially planar and is provided with a third hole 23, which is not threaded and is eccentric and has a diameter that is substantially equal to the diameter of the sleeve 13 and to the diameter of one of the circles 106a and 106b.

A raised portion 27 shaped like a parallelepiped furthermore protrudes from the plate 22, parallel to the oblique side 26 and so as to partially affect the shorter parallel side 25, and in turn a pin 28 protrudes from the raised portion substantially adjacent to the connection between the oblique side 26 and the shorter parallel side 25 and is adapted to keep the derailleur hook 14, once mounted, locked in the direction of a clockwise rotation and free to rotate counterclockwise only through a chosen arc.

When using for example the model UDH derailleur of the company SRAM DEUTSCHLAND GmbH, the pin 28 in fact must act as abutment for the front arm 29 of the derailleur hook 14 if the latter is imparted a counterclockwise rotation, the pin 28 being arranged at a given, chosen and precise distance from the axis of the pivot 100 of the chosen wheel.

When the first external adapter 10a is rotated through 180° (see FIGS. 7 and 17), the second internal adapter 10b is arranged differently with respect to the first internal seat 9 and at the same time the pin 28 moves, both axially and radially with respect to the first hole 6a, so as to maintain a precise distance from the axis of the pivot 100 of the wheel and allow the abutment therewith of the front arm 29 of the derailleur hook 14 upon a counterclockwise rotation.

This second internal adapter 10b therefore moves together with the axis of the pivot 100 of the wheel so as to always have the front arm 29 of the derailleur hook 14 at the correct distance in order to prevent a counterclockwise rotation.

A third external seat 31 and a fourth internal seat 32 for the axial and removable positioning respectively of a third external adapter 33a and of a fourth internal adapter 33b are provided at the second external surface 30a and at the second internal surface 30b of the support 5b, connected to the first left chainstay 3b and to the second left chainstay 4b.

The fourth internal adapter 33b has a substantially C-shaped configuration so as to form, in the external perimetric connection region of wings 34a, 34b, a substantially planar portion 35 which is connected, in the direction of the second chainstay 4b, by a tooth 36 that protrudes toward the first chainstay 3b.

The fourth internal seat 32 accommodates inside it the fourth internal adapter 33b and has, in the direction of the first chainstay 3b, a fifth seat 38 that is adapted to accommodate temporarily the complementarily shaped tooth 36; a sixth seat 39 is present and adjacent to the fifth seat 38, is similar to the preceding one and allows the selective positioning of the tooth 36 which makes the fourth internal adapter 33b translate in the direction of the second chainstay 4b.

An interspace is formed between the wings 34a, 34b of the fourth internal adapter 33b and allows, regardless of the position assumed by the fourth internal adapter 33b, to not occlude the first hole 6b which also has a figure-of-eight shape so as to form two contiguous and partially intersecting circles 106c, 106d, which are mutually identical and both have smooth internal surfaces, which in turn determine two different conditions for the positioning of the pivot 100 of the wheel.

The third adapter 33a has a triangular shape with rounded corners and can be inserted detachably in the third external seat 31.

One corner of the third adapter 33a is directed toward the first chainstay 3b and a fourth hole 40 is provided thereon and accommodates a screw 41 for its temporary insertion at a fifth through hole 42 provided in the fourth internal seat 32 in a region below the fifth seat 38 for the tooth 36.

The screw 41 is screwed onto a complementarily threaded sixth hole 43 provided in the fourth internal adapter 33b in a region below the fifth seat 38 when the tooth 36 is inserted in said fifth seat 38.

By moving the fourth internal adapter 33b so that the tooth 36 is arranged in the sixth seat 39, the sixth hole 43 also consequently moves at the same time; the screw 41 is thus fixed to a complementarily threaded seventh hole 44 provided in a region below the portion 35.

The third external adapter 33a is provided with an eighth hole 45, which is axially offset with respect to the intersection point of the heights, which is arranged either in axial alignment with the circle 106c or in axial alignment with the circle 106d.

The circles 106a, 106b and 106c, 106d are in fact respectively mutually axially aligned so that once the positioning of the first external adapter 10a and of the second internal adapter 10b has been defined, the third external adapter 33a is also positioned so that the pivot 100 of the wheel is in axial alignment either with the circles 106a, 106c or with the circles 106b, 106d.

It is thus possible to obtain two possible configurations, shown for example in FIGS. 3 and 7, in which it is possible to determine two different axial arrangements of the pivot 100 of said wheel with respect to the supports 5a, 5b of said first chainstays 3a, 3b and second chainstays 4a, 4b.

It has thus been found that the invention has achieved the intended aim and objects, a device having been obtained which allows to achieve, rapidly and simply, the installation on the rear stay of a bicycle of wheels having a different diameter despite the presence of a derailleur hook associated with the rear stay.

The changing of the wheel to be mounted, for example passing from 27.5″ wheels to 29″ wheels, can be obtained by the cyclist without particular tools or instruments and rapidly and simply.

Furthermore, the first external adapter 10a and the second internal adapter 10b have said second hole 12 and said third hole 23 which are not threaded, thus allowing the free passage of the pivot 100 of the wheel, the pivot being fixed to the derailleur hook 14 by means of the cap or cover 16.

This entails the absence of threaded seats in the first external adapter and in the second internal adapter or on the frame, since they are closed in a pack-like configuration by means of the derailleur hook 14.

This leads to great simplicity in the provision of the frame, with a consequent lower cost in the provision of said frame, greater speed and simplicity in changing from a wheel, passing for example from 27.5″ to 29″, since there are no screws for the fixing of the first external adapter 10a and of the second internal adapter 10b.

Furthermore, the device is compatible with a derailleur hook of the known type, even if it is of the UDH model of the company SRAM DEUTSCHLAND GmbH, which requires an abutment in the internal part of the frame, at a very precise distance with respect to the wheel axis.

By modifying in fact the position of the axis of the pivot 100 of the wheel it is in fact necessary to also modify this abutment and in the present device there are the first external adapter 10a and the second internal adapter 10b which allow to keep the derailleur hook 14 locked in rotation so that its axis and the axis of the wheel coincide.

The presence of the third external adapter 33a and of the fourth internal adapter 33b also allow to determine two different axial positions of the pivot 100 of the wheel with respect to the two first and second chainstays 3a, 3b, 4a, 4b, requiring a single screw for their mutual fixing.

Furthermore, the rotatable application of the derailleur allows, in case of impact of the derailleur against an object during the race, to rotate through a certain free arc and thus avoid breakage.

Furthermore, it is noted that even if wheel axes that are not at the same height from the ground should occur, it would be sufficient to move the fourth internal adapter 33b, which has the function of creating an abutment for the hub of the wheel during the mounting of the wheel in the frame, to always achieve the correct guiding for the insertion of the wheel hub until the correct position is reached.

The materials used, as well as the dimensions that constitute the individual components of the invention, may of course be more pertinent according to the specific requirements.

The characteristics indicated as advantageous, convenient or the like may also be omitted or be replaced with equivalents.

The disclosures in Italian Patent Application No. 102020000009499 from which this application claims priority are incorporated herein by reference.

What is claimed is:

1. A device for the selective positioning of a pivot of a wheel of a bicycle comprising a frame composed of a rear stay provided with a first pair of first oblique rear chainstays which are each connected, respectively by means of a triangular support, to a second pair of two second horizontal rear chainstays, a derailleur hook being associable with said first chainstays and second chainstays, wherein first external seats and second internal seats are provided at a first internal surface and at a first external surface of said support for an axial and removable positioning respectively of a first external adapter and of a second internal adapter and have respectively a second hole and a third hole, both of which are smooth and are adapted to determine two different axial arrangements of said derailleur hook and consequently of said pivot of said wheel with respect to said two first and second chainstays and are adapted to keep said derailleur hook locked in clockwise rotation and free to rotate counterclockwise only through a chosen arc.

2. The device according to claim 1, wherein said second chainstay is connected by said triangular support at a second internal surface and at a second external surface of which there are third external seats and fourth internal seats for the removable positioning, respectively, of a third external adapter and of a fourth internal adapter, which are adapted to determine two different axial arrangements of said wheel with respect to said two first and second chainstays.

3. The device according to claim 1, wherein said first and second pairs of chainstays have, at a vertex of said triangular supports, a first hole which has a figure-of-eight shape, said first hole forming two circles, which are contiguous mutually identical and partially intersect each other and both have smooth internal surfaces, which in turn determine two different conditions for an arrangement of said derailleur hook and of said pivot of said wheel.

4. The device according to claim 3, wherein said first external adapter has a first head, having a substantially elliptical plan shape, provided with a second hole, which is not threaded and eccentric and has a diameter that is substantially equal to that of a sleeve of said derailleur hook, said second hole having a diameter that is substantially equal to a diameter of one of said circles, on the side of said first head that is opposite the one on which said second hole is provided there protruding a first stem, which is therefore axially offset with respect to said second hole, which is shaped so that it can be inserted selectively in one of said two circles following a 180° rotation of said first external adapter so as to define two possible configurations in which it is possible to determine two different axial arrangements of said pivot of said wheel with respect to said support of said first chainstay.

5. The device according to claim 3, wherein said second internal seat has a substantially scalene trapezoid shape with a longer parallel side which follows the shape of a lower side of said triangular support, a shorter parallel side which has, from the vertex of said triangular support toward said second chainstay, a given inclination towards the underlying longer parallel side, and an oblique side for connection between said longer parallel side and said shorter parallel side that is directed in a direction of said second chainstay.

6. The device according to claim 5, wherein said second internal adapter is constituted by a plate, which is shaped complementarily to said second internal seat, has a substantially flat shape and is provided with said third hole, which is not threaded and is eccentric and has a diameter that is substantially equal to the diameter of said sleeve and to the diameter of one of said circles, a raised portion shaped like a parallelepiped protruding from said plate parallel to said oblique side and so as to partially affect said shorter parallel side, a pin protruding in turn from said raised portion substantially adjacent to the connection between said oblique side and said shorter parallel side, said pin being adapted to keep said derailleur hook, once fitted, locked in the direction of a clockwise rotation and free to rotate in a counterclockwise direction only through a chosen arc.

7. The device according to claim 6, wherein upon a 180° rotation of said first external adapter said second internal adapter is arranged differently with respect to said first internal seat and at the same time said pin moves, both axially and radially to said first hole, so as to maintain a precise distance from the axis of said pivot of the wheel and allow the abutment therewith of a front arm of said derailleur hook upon a counterclockwise rotation.

8. The device according to claim 2, wherein at the second external surface and at the second internal surface of said triangular support, connected to said first and second chainstays, there are said third external seat and said fourth internal seat for the axial and removable positioning respectively of said third external adapter and of said fourth internal adapter, said fourth internal adapter being substantially C-shaped so as to form, in an external perimetric region for connection of wings, a substantially planar portion which is connected, in a direction of said second chainstay, by a tooth that protrudes toward said first chainstay, said fourth internal seat accommodating inside it said fourth internal adapter and having, in the direction of said first chainstay, a fifth seat that is adapted to accommodate temporarily said complementarily shaped tooth, adjacent to said fifth seat there being a sixth seat, which is similar to the preceding one and is adapted to allow the selective positioning of said tooth which makes said fourth internal adapter translate in the direction of said second chainstay.

9. The device according to claim 8, wherein an interspace is formed between said wings of said fourth internal adapter and allows, whatever the position assumed by said fourth internal adapter, to avoid occluding said first hole, which also has a figure-of-eight shape so as to form two contiguous and partially intersecting circles, which are mutually identical and both have smooth internal surfaces, which in turn determine two different conditions for the positioning of said pivot.

10. The device according to claim 8, wherein said third adapter has a triangular shape with rounded corners and can be inserted detachably in said third external seat, one vertex of said third adapter being directed toward said first chainstay, a fourth hole being provided thereon and accommodating a screw for its temporary insertion at a fifth through non-threaded hole provided in said fourth internal seat in a region below said fifth seat for said tooth, said screw being screwed onto a complementarily threaded sixth hole provided in said fourth internal adapter in a region that lies below said fifth seat when said tooth is inserted in said fifth seat.

11. The device according to claim 10, wherein a movement of said fourth internal adapter so that said tooth is arranged in said sixth seat causes a simultaneous movement also of said complementarily threaded sixth hole, said screw being fixed consequently to a complementarily threaded seventh hole provided in a region below said portion.

12. The device according to claim 11, wherein said third external adapter is provided with an eighth hole, which is axially offset with respect to the intersection point of the heights, and is arranged either in axial alignment with said circle or in axial alignment with said circle, said circles and being respectively axially aligned with each other, so that once the positioning of said first external adapter and of said second internal adapter has been defined, said third external adapter also is positioned so that said pivot of said wheel is axially aligned either with said circles or with said circles.
